(19) United States
(12) Patent Application Publication
(10) Pub. No.: US 2008/0261766 A1
(43) Pub. Date: Oct. 23, 2008

(54) Automatic Transmission

(75) Inventors: Takao Koyama, Atsugi-shi (JP); Yukio Nagahori, Tsurumi-ku (JP); Katsuya Tanoue, Kawasaki-ku (JP); Yousuke Hori, Isehara-shi (JP); Yusuke Miyamoto, Nishi-ku (JP)

Correspondence Address: YOUNG & BASILE, P.C., 3001 WEST BIG BEAVER ROAD, SUITE 624, TROY, MI, 48084, US

(73) Assignee: Nissan Motor Co., Ltd., Yokohama-shi (JP)

(21) Appl. No.: 10/574,155

(22) PCT Filed: Nov. 1, 2005
(86) PCT No.: PCT/IB2005/003258

§ 371 Date: Mar. 27, 2006

(30) Foreign Application Priority Data
Nov. 2, 2004 (JP) 2004-319831

(51) Int. Cl. F16H 3/44

(52) U.S. Cl. 475/280

(57) ABSTRACT

A structure is given where the automatic transmission includes a planetary gear unit, a plurality of engagement elements to disconnect or fix elements of the planetary gear unit, a variable speed control that selects a low-speed forward gear as the vehicle first starts to move, a high-speed forward gear when the vehicle is moving forward, and a reverse gear when the vehicle is moving reverse by disconnecting or fixing the plurality of engagement elements. Embodiments may provide an advantage in layout by reducing a high-torque starting element and a forward/reverse shift element into a single planetary gear unit.

### TECHNICAL FIELD

The invention relates to automatic transmissions for vehicles.

### BACKGROUND

Automatic transmissions generally include frictional engagement elements such as a planetary gear unit, a clutch and a brake. Automatic transmissions may be generally composed of a torque converter, a forward/reverse shift mechanism, a belt or chain drive continuously variable transmission mechanism, and a differential mechanism in a transmission casing.

Automatic transmissions generally have a large axial dimension, due to the in-line placement of components. Such components include a torque converter, forward/reverse shift mechanism which changes between a forward rotation and a reverse rotation by using planetary gears. The components are positioned in the axial direction in series between an engine and the continuously variable transmission mechanism.

Alternatively, an automatic transmission may include a low-speed gear and a high-speed gear as high-torque starting elements instead of a torque converter. However, such automatic transmissions also have a large axial dimension. A sub-transmission serving as a high-torque starting element is positioned in series with a forward/reverse shift mechanism that uses planetary gears.

For this reason, a conventional design to arrange a high-torque starting element and forward/reverse shift element in series in the axial direction has limitations in downsizing and weight saving of the automatic transmission, and a disadvantage in in-vehicle installability.

### SUMMARY

In general, the present disclosure is directed to an automatic transmission that combines the function of a high-torque starting element and a forward/reverse shift mechanism into a planetary gear unit including a set of planetary gear elements. A set of planetary gear elements generally includes a sun element, a carrier element and a ring element; it may also include a fixed housing.

In one embodiment, the invention is directed to an automatic transmission comprising a planetary gear unit coupled a transmission mechanism, wherein a drive train pathway of the automatic transmission includes the transmission mechanism and the planetary gear unit, and a plurality of engagement elements that engage to couple planetary gear elements of the planetary gear unit. The plurality of engagement elements are selectively engaged to provide each of a set of selectable gears. The set of selectable gears includes a low-speed forward gear, a high-speed forward gear, and a reverse gear.

### BRIEF DESCRIPTION OF DRAWINGS

FIG. 1 is a complete system chart showing a vehicle drive system with an automatic transmission A1.

FIG. 2 is a drawing showing the automatic transmission A1.

FIG. 3 is a table showing behaviors of clutches and brakes of each variable speed gear of the automatic transmission A1.

FIG. 4 is a diagram showing a correlation of the number of rotations among each variable speed gear of the automatic transmission A1.

FIG. 5 is a drawing showing an automatic transmission A2.

FIG. 6 is a table showing behaviors of clutches and brakes of each variable speed gear of the automatic transmission A2.

FIG. 7 is a diagram showing a correlation of the number of rotations among each variable speed gear of the automatic transmission A2.

FIG. 8 is a drawing showing an automatic transmission A3.

FIG. 9 is a table showing behaviors of clutches and brakes of each variable speed gear of the automatic transmission A3.

FIG. 10 is a diagram showing a correlation of the number of rotations among each variable speed gear of the automatic transmission A3.

FIG. 11 is a complete system chart showing a vehicle drive system with an automatic transmission A4.

FIG. 12 is a drawing showing the automatic transmission A4.

FIG. 13 is a table showing behaviors of clutches and brakes of each variable speed gear of the automatic transmission A4.

FIG. 14 is a diagram showing a correlation of the number of rotations among each variable speed gear of the automatic transmission A4.

FIG. 15 is a drawing showing a pinion carrier structure which supports a double pinion with a conventional technology.

FIG. 16 is a drawing showing a pinion carrier structure which supports a double pinion.

FIG. 17 is a drawing showing an automatic transmission A5.

FIG. 18 is a table showing behaviors of clutches and brakes of each variable speed gear of the automatic transmission A5.

FIG. 19 is a diagram showing a correlation of the number of rotations among each variable speed gear of the automatic transmission A5.

FIG. 20 is a drawing showing an automatic transmission A6.

FIG. 21 is a table showing behaviors of clutches and brakes of each variable speed gear of the automatic transmission A6.

FIG. 22 is a diagram showing a correlation of the number of rotations among each variable speed gear of the automatic transmission A6.

FIG. 23 is a drawing showing an alternative arrangement of an automatic transmission.

### DETAILED DESCRIPTION

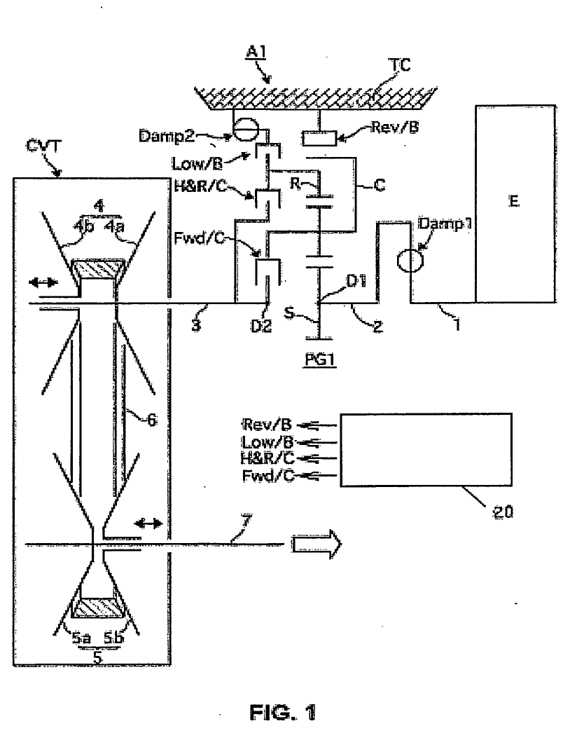

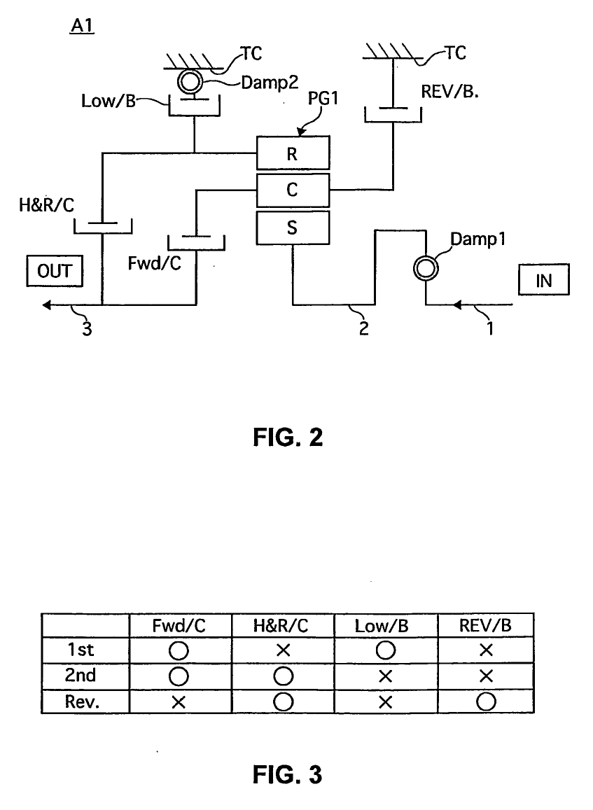

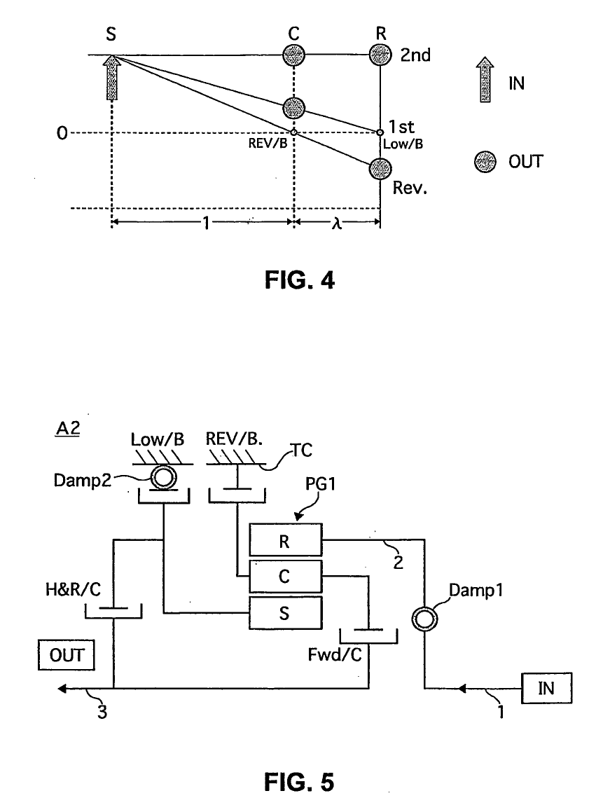

A first exemplary embodiment is described with reference to FIGS. 1-4. In particular, FIG. 1 is a complete system chart showing a vehicle drive system including an automatic transmission A1. FIG. 2 is a drawing showing the automatic transmission A1. FIG. 3 is a table showing behaviors of clutches and brakes of each variable speed gear of the automatic transmission A1. FIG. 4 is a diagram showing a correlation of the number of rotations among each variable speed gear of the automatic transmission A1.

As shown in the FIG. 1, a vehicle drive system includes an engine E, an automatic transmission A1, and a continuously variable transmission mechanism CVT.

The engine E is a gasoline engine or a diesel engine as a source of power, and an input shaft 2 of the automatic transmission A1 is coupled to an engine output shaft 1.

The belt continuously variable transmission mechanism CVT acquires rotations of an output shaft 3 of the automatic transmission A1 as input rotations; and outputs rotations from an output shaft of the transmission 7 to the differential mechanism outside the drawing by continuously changing a transmission gear ratio depending on the contact diameter of a steel belt 6 which is tied over a primary pulley 4 and a secondary pulley 5. The primary pulley 4 includes a fixed pulley 4a and a mobile pulley 4b. The secondary pulley 5 includes a fixed pulley 5a and a mobile pulley 5b. The mobile pulleys 4b, Sb are controlled so as to achieve an intended transmission gear ratio (ratio of the contact diameter of a belt) by putting hydraulic pressure controlled by a variable speed pressure control unit outside the drawing on each pulley chamber.

The automatic transmission A1 includes a planetary gear unit including a set of planetary gear elements (a single pinion planetary gear unit PG1); a plurality of frictional engagement elements to disconnect or fix the planetary gear elementss (a forward clutch Fwd/C, a high/reverse clutch H&R/C, a low brake Low/B, a reverse brake REV/B); a variable speed control to obtain a low-speed forward gear 1st selected as the vehicle first starts to move, a high-speed forward gear 2nd selected when the vehicle is moving forward, and a reverse gear Rev selected when the vehicle is moving reverse by a combination of connection and release of the plurality of frictional engagement elements.

A first damper Damp1 includes in a drive train pathway of all variable speed gears, and a second damper Damp2 includes in a drive train pathway of at least a low-speed forward gear among coupling members to couple the interspaces between a rotatory element of the planetary gear unit, input/output shafts 2 and 3, and a transmission casing TC. According to the first exemplary embodiment, a first damper Damp1 includes between an engine output shaft 1 and an input shaft 2; and a second damper Damp2 includes between a low brake Low/B and a transmission casing TC as shown in FIG. 1.

In the embodiment shown in FIG. 1, the planetary gear unit is a single pinion planetary gear unit PG1 with a sun gear S, a pinion carrier C, and a ring gear R as rotatory elements, the sun gear S is coupled to an input shaft 2. The pinion carrier C is coupled to a transmission casing TC by engaging the reverse brake REV/B, and at the same time, coupled to the output shaft 3 by engaging a forward clutch Fwd/C. The ring gear R is coupled to the transmission casing TC by engaging a low brake Low/B, and at the same time coupled to an output shaft 3 by engaging a hi/reverse clutch H&R/C.

The variable speed control comprisess a low-speed forward gear 1st with the forward clutch Fwd/C and the low brake Low/B coupled, a high-speed forward gear 2nd with the forward clutch Fwd/C and the high/reverse clutch H&R/C coupled, and a reverse gear Rev. with the high/reverse clutch H&R/C and reverse brake REV/B coupled (refer to FIG. 3).

As shown in FIG. 1, the single pinion planetary gear unit PG1 and the reverse brake REV/B are positioned on a first common axis D1. The low brake Low/B, the high/reverse clutch H&R/C, and the forward clutch Fwd/C are positioned on a second common axis D2 adjacent to the first common axis D1. The reverse brake REV/B is a band-braking system where a brake drum provided on the outer circumference of a ring gear R is fixed on a transmission casing TC by tightening with a band. A controller 20 outputs indicating signals according to shift position operated by a driver or detecting sensors which detect vehicle behavior to switch for engaging or disengaging of the reverse brake REV/B, forward clutch Fwd/C, low brake Low/B, and a hi/reverse clutch H&RIC.

FIG. 2 is a drawing showing the automatic transmission A1. A sun gear S of a single pinion planetary gear unit PG1 is coupled to an input shaft 2. A pinion carrier C of a single pinion planetary gear unit PG1 is coupled to a transmission casing TC by engaging a reverse brake REV/B, and at the same time, coupled to an output shaft 3 by engaging a forward clutch Fwd/C. A ring gear R of a single pinion planetary gear unit PG1 is coupled to a transmission casing TC by engaging a low brake Low/B, and at the same time, coupled to an output shaft 3 by engaging a high/reverse clutch H&R/C. In addition, a first damper Damp1 includes between the input shaft 2 and an engine output shaft 1; and a second damper Damp2 includes between the low brake Low/B and a transmission casing TC.

FIG. 3 is a table showing behaviors of clutches and brakes of each variable speed gear of the automatic transmission A1. A low-speed forward gear 1st is obtained by coupling a forward clutch Fwd/C and a low brake Low/B, and releasing a high/reverse clutch H&R/C and a reverse brake REV/B. A high-speed forward gear 2nd is obtained by coupling a forward clutch Fwd/C and a high/reverse clutch H&R/C, and releasing a low brake Low/B and a reverse brake REV/B. A reverse gear Rev. is obtained by coupling a high/reverse clutch H&R/C and a reverse brake REV/B, and releasing a forward clutch Fwd/C and a low brake Low/B.

FIG. 4 is a diagram showing a correlation of the number of rotations among each variable speed gear of the automatic transmission A1. As shown in the FIG. 4, as to a correlation of the number of rotations among a low-speed forward gear 1st, a high-speed forward gear 2nd, and a reverse gear Rev., a rigid lever model (a correlation where the number of each three rotation is always connected by a straight line) can be introduced to exhibit dynamic movements of a single pinion planetary gear unit PG1 with a simple method.

The “diagram” is a velocity diagram which can determine the gear ratio of a differential gear with faster and more easily than mathematical formulas, where the longitudinal shaft shows the number of rotations (rotational speed) among each rotatory element, the longitudinal shaft shows each rotatory element, and the clearance among each rotatory element is positioned so as to be a lever ratio of the diagram based on a gear ratio λ (usually 0.3-0.6) of a sun gear S and a ring gear R. Incidentally, each rotatory element of a single pinion planetary gear unit PG1 is positioned in the diagram in the order of a sun gear S, a pinion carrier C, and a ring gear R. The clearance between the pinion carrier C and the ring gear R is the gear ratio λ given that the clearance between the sun gear S and the pinion carrier C is 1.

As compared to the prior art, an automatic transmission A1 includes a high-torque starting element and a forward/reverse shift element combined as a single pinion planetary gear unit PG1, and has an advantage in layout after being equipped with a low-speed forward gear 1st selected as the vehicle first starts to move, a high-speed forward gear 2nd selected when the vehicle is moving forward, and a reverse gear Rev. when the vehicle is moving reverse by combining the high-torque starting element and forward/reverse shift element as a single pinion planetary gear unit PG1, and two clutches and brakes which connect or fix a the single pinion planetary gear unit PG1.

In other words, for example, as the vehicle first starts to move under the circumstances that a continuously variable transmission mechanism CVT is in the maximum speed reduction ratio, input torque from an engine E will increase depending on a speed reduction ratio by selecting a low-speed forward gear 1st because the engine E will be reducing the speed with the number of output rotations from a pinion career C smaller than the number of input rotations into a sun gear S, and with a forward clutch Fwd/C and a low brake Low/B coupled as shown by the 1st lever in FIG. 4.

As the vehicle first starts to move, for example, the startup characteristics of the input torque into a continuously variable transmission mechanism CVT can be controlled so as to ensure the optimal characteristics by coupling a low brake Low/B before a forward clutch Fwd/C, and by controlling the coupling pressure of the forward clutch Fwd/C depending on the degrees and speed of the accelerator to be depressed.

After startup, for example, by selecting a high-speed forward gear 2nd as shown by the 2nd lever in FIG. 4 when a speed of car reaches the predetermined speed, the transmission gear ratio will be controlled at the side of a continuously variable transmission mechanism CVT because a forward clutch Fwd/C and a high/reverse clutch H&R/C are coupled. The number of input rotations from a sun gear S, and the number of output rotations from a pinion career C and a ring gear R become the same value (transmission gear ratio=1). The input torque from an engine E and the number of rotations are directly input into the belt continuously variable transmission mechanism CVT.

Changeover between a low-speed forward gear 1st and a high-speed forward gear 2nd is made by application change control where a low brake Low/B coupled to the low-speed forward gear 1st is released with a forward clutch Fwd/C remaining coupled, and a high/reverse clutch H&R/C released by the low-speed forward gear 1st is coupled.

As shown by the Rev. lever in FIG. 4, by selecting a reverse gear Rev., the number of input rotations from a ring gear R and the number of output rotations from a sun gear S will create a rotational state in the reverse direction by coupling a high/reverse clutch H&R/C and a reverse brake REV/B. The vehicle will be put into reverse by inputting rotations in the reverse direction into a continuously variable transmission mechanism CVT from an output shaft 3.

When the vehicle is moving reverse, for example, the startup characteristics of the input torque into a continuously variable transmission mechanism CVT can be controlled so as to ensure the optimal characteristics. As the vehicle first starts to move, by coupling a reverse brake REB/B before a high/reverse clutch H&R/C, and by controlling the coupling pressure of the high/reverse clutch H&R/C depending on the degrees and speed of the accelerator to be depressed.

Thus, such is the case with the automatic transmission A1, it performs the function of a high-torque starting element by selecting a low-speed forward gear 1^{st}. After the vehicle starts to move, it selects a high-speed forward gear 2^{nd}. A reverse gear Rev. allows the vehicle to moving backwards. The arrangement of the described embodiments allows a reduced size in the axial direction by combining the high-torque starting element and forward/reverse shift element into a single pinion planetary gear unit PG1, instead of having a separate a high-torque starting element and forward/reverse shift element.

Moreover, in an automatic transmission A1, a first damper Damp1 includes between an engine output shaft 1 and an input shaft 2; and a second damper Damp2 includes between a low brake Low/B and a transmission casing TC as shown in FIGS. 1 and 2. Consequently, the optimum damper characteristics can be given in a low-speed gear mode and a high-speed gear mode respectively. In fact, the second damper Damp2 for the low-speed gear mode is cut off from torque flow when the high-speed forward gear 2nd and the reverse gear Rev. Are selected, and therefore an optimally functioning design is available only when a low-speed forward gear 1st is selected. On the other hand, in the first damper Damp1 for the high-speed gear mode, an optimally functioning design is available when a high-speed forward gear 2nd is selected.

The first exemplary embodiment may provide one or more of the following advantages. First, an advantage can be given in layout to the automatic transmission by combining the high-torque starting element and forward/reverse shift element as a single pinion planetary gear unit.

Second, the optimum damper characteristics can be given in a low-speed gear mode and a high-speed gear mode respectively because a first damper Damp1 includes in the drive train pathways of all variable speed gear, and a second damper Damp2 includes in the drive train pathways of at least a low-speed forward gear 1st of a coupling member to couple interspaces between rotatory elements of the planetary gear unit, input/output shafts 2 and 3, and a transmission casing TC.

Third, the planetary gear unit s is a single pinion planetary gear unit PG1 with a sun gear S, a pinion carrier C, and a ring gear R as rotatory elements. The sun gear S is coupled to an input shaft 2. The pinion carrier C is coupled to a transmission casing TC by engaging a reverse brake REV/B, and at the same time, coupled to an output shaft by engaging a forward clutch Fwd/C. The ring gear R is coupled to the transmission casing TC by engaging the low brake Low/B, and at the same time coupled to an output shaft 3 by engaging a hi/reverse clutch H&R/C; and a high-torque starting element and a forward/reverse shift element can be reduced as a single pinion planetary gear unit PG1, two clutches Fwd/C and H&R/C, and two brakes Low/B and REV/B because the variable speed control comprises a low-speed forward gear 1st with a forward clutch Fwd/C and low brake Low/B coupled, a high-speed forward gear 2nd with the forward clutch Fwd/C and the high/reverse clutch H&R/C coupled, and a reverse gear with the high/reverse clutch H&R/C and the reverse brake REV/B coupled.

Fourth, cost reduction can be achieved by standardizing and using common parts for rotatory members, and size can be reduced in the axial direction better than arranging frictional engagement elements at a distant position in the axial direction because a single pinion planetary gear unit PG1 and a reverse brake REV/B are positioned on a first common axis D1 as shown in FIG. 1; and a low brake Low/B, a high/reverse clutch H&R/C, and a forward clutch Fwd/C are arranged on a second common axis D2 parallel to the first common axis D1.

In fact, common parts can be used as rotatory members adjacent to each frictional engagement element by making each frictional engagement element (a low brake Low/B, a high/reverse clutch H&R/C, a forward clutch Fwd/C) three-layer structure.

Fifth, dimensions of a reverse brake REV/B can be reduced in the radial direction by adopting a band-braking system better than by adopting a multiplate brake system.

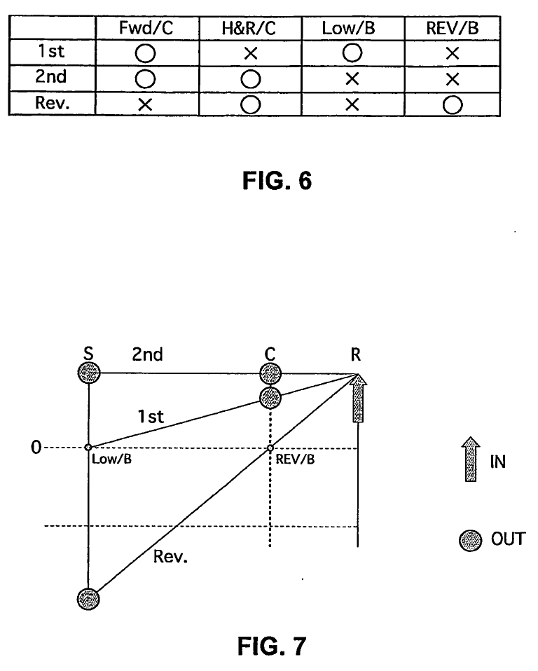

The second exemplary embodiment is described with reference to FIGS. 5-7. In particular, FIG. 5 is a drawing showing the automatic transmission A2. FIG. 6 is a table showing behaviors of clutches and brakes of each variable speed gear of the automatic transmission A2. FIG. 7 is a diagram showing a correlation of the number of rotations among each variable speed gear of the automatic transmission A2.

The second exemplary embodiment shows an example of a speed-up reverse gear Rev with a sun gear input by using a single pinion planetary gear unit. In addition, the first exemplary embodiment is an example of a reduction reverse gear Rev. with a ring gear input by using the single pinion planetary gear unit.

As shown in FIG. 5, an automatic transmission A2 is the single pinion planetary gear unit with a sun gear S, a pinion carrier C, and a ring gear R as rotatory elements, the sun gear S is coupled to a transmission casing TC by engaging a low brake Low/B, and at the same time coupled to an output shaft 3 by engaging a hi/reverse clutch H&R/C. The pinion carrier C is coupled to the transmission casing TC by engaging a reverse brake REV/B, and at the same time, coupled to the output shaft 3 by engaging a forward clutch Fwd/C. The ring gear R is coupled to an input shaft 2.

As shown in FIG. 6, the variable speed control comprises a low-speed forward gear with a forward clutch Fwd/C and a low brake Low/B coupled, a high-speed forward gear coupled to the forward clutch Fwd/C and a high/reverse clutch H&R/C, and a reverse gear coupled to the high/reverse clutch H&R/C and a reverse brake REV/B. Many structures the are the same in the second exemplary embodiment as the first exemplary embodiment as not redundantly described.

The transmission operates at variable speeds as follows. As the vehicle first starts to move, input torque from an engine E will increase depending on a speed reduction ratio by selecting a low-speed forward gear 1st with a forward clutch Fwd/C and a low brake Low/B coupled because the engine will be reducing the speed with the number of output rotations from a ring gear R smaller than the number of input rotations into a pinion carrier C as shown by the 1st lever in FIG. 7.

After startup, for example, by selecting a high-speed forward gear 2nd when a speed of car reaches the predetermined speed, a forward clutch Fwd/C and a high/reverse clutch H&R/C are coupled as shown by the 2nd lever in FIG. 7. The transmission gear ratio is controlled at the side of a continuously variable transmission mechanism CVT because the number of input rotations from a ring gear R, and the number of output rotations from a sun gear S and a pinion career C becomes the same value (transmission gear ratio). The input torque from an engine E and the number of rotations are directly input into the belt continuously variable transmission mechanism CVT.

As shown by the Rev. lever in FIG. 7, by selecting a reverse gear Rev., the number of input rotations from a ring gear R and the number of output rotations from a sun gear S will create a rotational state in the reverse direction by coupling a high/reverse clutch H&R/C and a reverse brake REV/B. The vehicle will be put into reverse by inputting rotations in the reverse direction into a continuously variable transmission mechanism CVT from an output shaft 3.

Thus, such is the case with the automatic transmission A2, it performs the function of a high-torque starting element by selecting a low-speed forward gear 1st as the vehicle first starts to move; and it performs the function of a forward/reverse shift mechanism by selecting a high-speed forward gear 2nd when the vehicle is moving forward, and a reverse gear Rev. when the vehicle is moving reverse. Size can be reduced in the axial direction by forming a high-torque starting element and a forward/reverse shift element from a single pinion planetary gear unit PG1 compared with a conventional technology to arrange the high-torque starting element and the forward/reverse shift element separately.

The second exemplary embodiment may provide one or more of the following advantages. In the automatic transmission as described with respect to the second exemplary embodiment, the following listed effects, in addition to the first and second advantages described with respect to the first exemplary embodiment, can result.

Sixth, a planetary gear unit including a set of planetary gear elements is a single pinion planetary gear unit PG1 with a sun gear S, pinion a carrier C, and a ring gear R as rotatory elements, the sun gear S is coupled to a transmission casing TC by engaging a low brake Low/B and at the same time, coupled to an output shaft 3 by engaging a hi/reverse clutch H&R/C. The pinion carrier C is coupled to the transmission casing TC by engaging a reverse brake REV/B, and at the same time, coupled to the output shaft 3 by engaging a forward clutch Fwd/C. The ring gear R is coupled to an input shaft 2; and a high-torque starting element and a forward/reverse shift element can be reduced as a single pinion planetary gear unit PG1, two clutches Fwd/C and H&R/C, and two brakes Low/B and REV/B because the variable speed control comprises a low-speed forward gear with the forward clutch Fwd/C and the low brake Low/B coupled, a high-speed forward gear with the forward clutch Fwd/C and the high/reverse clutch H&R/C coupled, and a reverse gear with the high/reverse clutch H&R/C and the reverse brake REV/B coupled.

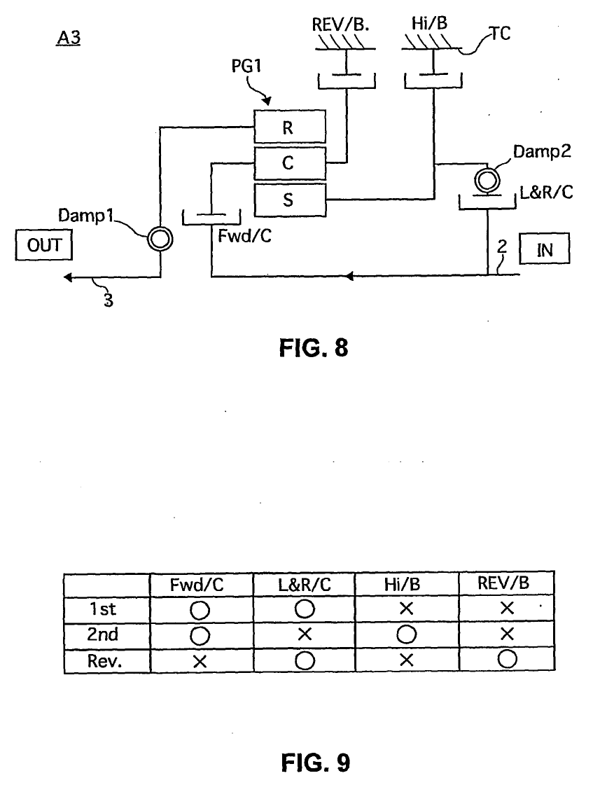

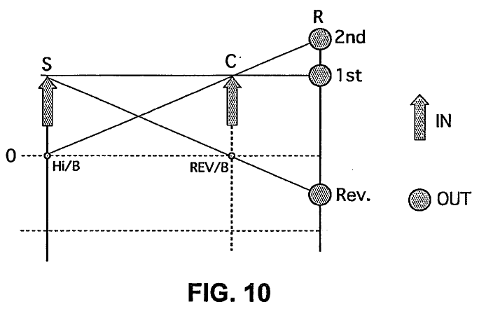

A third exemplary embodiment is described with reference to FIGS. 8-10. In particular, FIG. 8 is a drawing showing the automatic transmission A3. FIG. 9 is a table showing behaviors of clutches and brakes of each variable speed gear of the automatic transmission A3. FIG. 10 is a diagram showing a correlation of the number of rotations among each variable speed gear of the automatic transmission A3.

The third exemplary embodiment shows an example of a ring gear output using a single pinion planetary gear unit with an input from a sun gear or a pinion carrier.

FIG. 8 illustrates a single pinion planetary gear unit with a sun gear S, a pinion carrier C, and a ring gear R as rotatory elements. The sun gear S is coupled to a transmission casing TC by engaging a low brake Low/B, and at the same time coupled to an output shaft 3 by engaging a hi/reverse clutch H&R/C. The pinion carrier C is coupled to the transmission casing TC by engaging a reverse brake REV/B, and at the same time, coupled to the output shaft 3 by engaging a forward clutch Fwd/C. The ring gear R is coupled to an input shaft 2.

As shown in FIG. 9, the variable speed control comprises a low-speed forward gear with a forward clutch Fwd/C and a low brake Low/B coupled, a high-speed forward gear with the forward clutch Fwd/C coupled to the high brake Hi/B, and a reverse gear with a low/reverse clutch L&R/C and a reverse brake REV/B coupled.

Moreover, a first damper Damp1 includes at some midpoint in a rotatory member that couples a sun gear S and a low/reverse clutch L&R/C; and a second damper Damp2 includes at some midpoint in a rotatory member that couples a ring gear R and an output shaft 3.

The transmission operates at variable speeds as follows. By selecting a low-speed forward gear 1st as shown by the 1st lever in FIG. 10, as the vehicle first starts to move, the transmission gear ratio will be controlled at the side of the continuously variable transmission mechanism CVT because a forward clutch Fwd/C and a low/reverse clutch L&R/C are coupled. The number of input rotations from a sun gear S, and the number of output rotations from a ring gear R and a pinion career C becomes the same value (transmission gear ratio=1). The input torque from and the number of rotations from an engine E are directly input into the belt continuously variable transmission mechanism CVT. In other words, in the third exemplary embodiment, a low-speed forward gear 1st is a direct-coupled gear, which is not provided with torque increment functions; however, for example, if a speed reduction ratio is secured at the side of a continuously variable transmission mechanism CVT, at least one out of a forward clutch Fwd/C and a low/reverse clutch L&R/C can be hydraulically controlled as a starting clutch, and can function as a high-torque starting element.

After startup, for example, by selecting a high-speed forward gear 2nd as shown by the 2nd lever in FIG. 10 when a speed of car reaches the predetermined speed, the total transmission gear ratio will be fixed depending on an overdrive transmission gear ratio of an automatic transmission A3 of the third exemplary embodiment and a transmission gear ratio of a continuously variable transmission mechanism CVT because a forward clutch Fwd/C and a high brake Hi/B are coupled. The number of output rotations from a ring gear R will be larger than the number of input rotations from a pinion carrier C. The input torque from an engine will be reduced, the number of input rotations from an engine E will be increased to be input into the continuously variable transmission mechanism CVT. As shown by the Rev. lever in FIG. 10, by selecting a reverse gear Rev., the number of input rotations from a sun gear S and the number of output rotations from a ring gear R will create a rotational state in the reverse direction by coupling a low/reverse clutch L&R/C and a reverse brake REV/B. The vehicle will be put into reverse by inputting rotations in the reverse direction into a continuously variable transmission mechanism CVT from the output shaft 3.

Thus, such is the case with the automatic transmission A3, it performs the function of a high-torque starting element by selecting a low-speed forward gear 1st as the vehicle first starts to move. It performs the function of a forward/reverse shift mechanism by selecting a high-speed forward gear 2nd when the vehicle is moving forward, and a reverse gear Rev. when the vehicle is moving reverse. Size can be reduced in the axial direction by forming a high-torque starting element and a forward/reverse shift element from a single pinion planetary gear unit PG1 compared with a conventional technology to arrange the high-torque starting element and the forward/reverse shift element separately.

The third exemplary embodiment may provide one or more of the following advantages. In the automatic transmission as described with respect to the third exemplary embodiment, the following listed effects, in addition to the first and second advantages described with respect to the first exemplary embodiment, can result.

Seventh, a planetary gear unit including a set of planetary gear elements is a single pinion planetary gear unit PG1 with a sun gear S, a pinion carrier C, and a ring gear R as rotatory elements, the sun gear S is coupled to a transmission casing TC by engaging a high brake Hi/B and at the same time, coupled to an input shaft 2 by engaging a hi/reverse clutch H&R/C. The pinion carrier C is coupled to the transmission casing TC by engaging a reverse brake REV/B, and at the same time, coupled to the input shaft 2 by engaging a forward clutch Fwd/C. The ring gear R is coupled to an output shaft 3. A high-torque starting element and a forward/reverse shift element can be reduced as a single pinion planetary gear unit PG1, two clutches Fwd/C and L&R/C, and two brakes Hi/B and REV/B because the variable speed control consists of a low-speed forward gear with the forward clutch Fwd/C coupled to a low/reverse clutch L&R/C, a high-speed forward gear with the forward clutch Fwd/C coupled to the high brake Hi/B, and a reverse gear with the low/reverse clutch L&R/C coupled to the reverse brake REV/B.

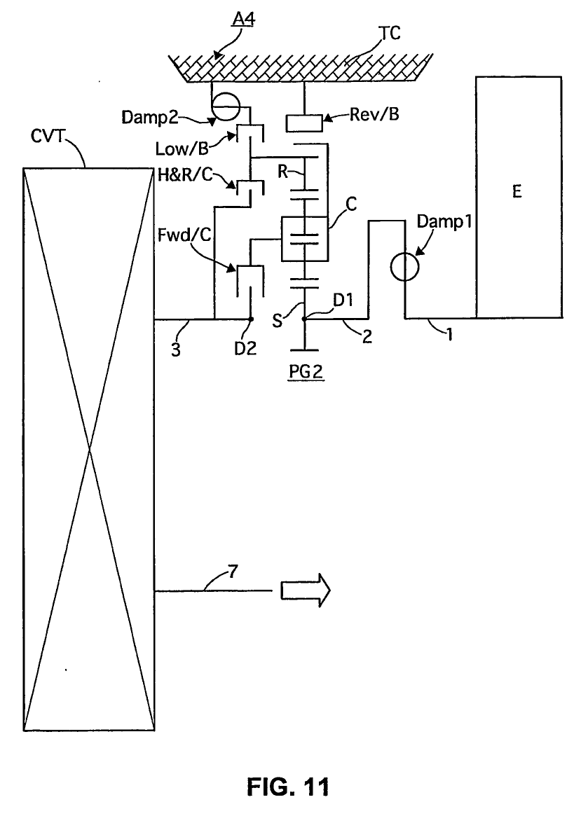

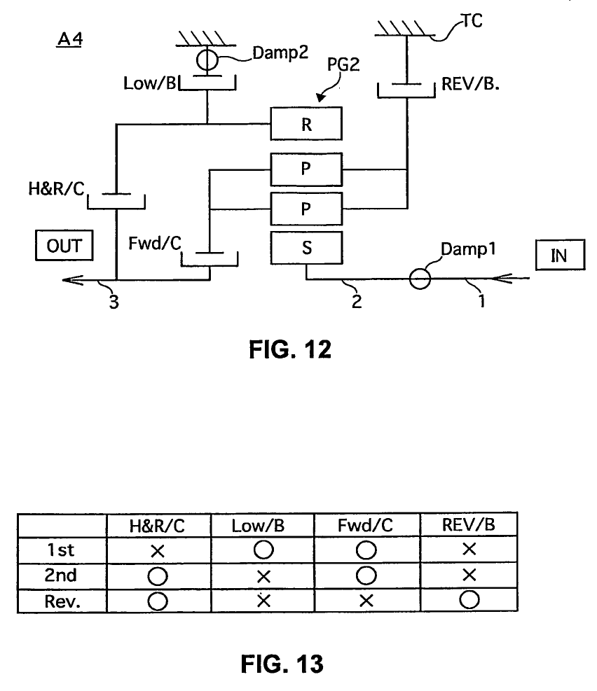

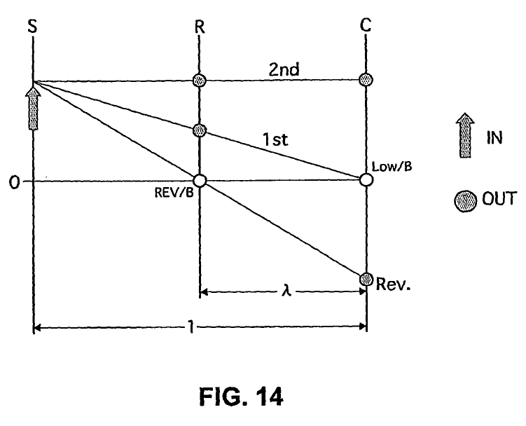

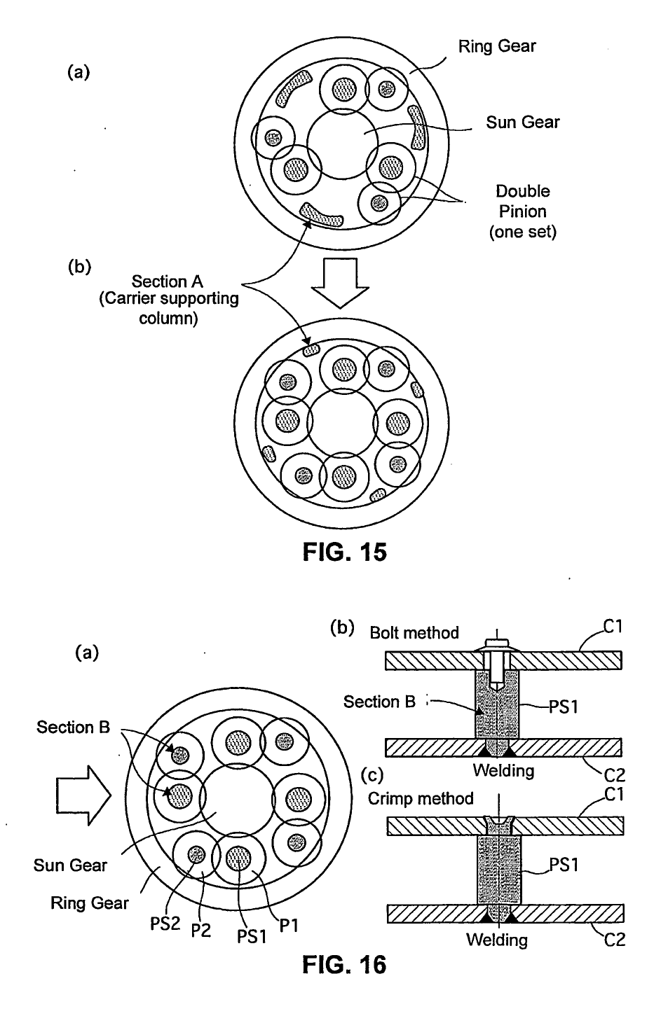

A fourth exemplary embodiment is described with reference to FIGS. 11-16. In particular, FIG. 11 is a complete system chart showing a vehicle drive system to which an automatic transmission A4. FIG. 12 is a drawing showing the automatic transmission A4. FIG. 13 is a table showing behaviors of clutches and brakes of each variable speed gear of the automatic transmission A4. FIG. 14 is a diagram showing a correlation of the number of rotations among each variable speed gear of the automatic transmission A4. FIG. 15 is a drawing showing a pinion carrier structure which supports a double pinion with a conventional technology. FIG. 16 is a drawing showing a pinion carrier structure which supports a double pinion.

The fourth exemplary embodiment shows an example of a ring gear output using a double pinion planetary gear unit with an input from a sun gear, and output from a pinion carrier or a ring gear.

FIG. 11 is a complete system chart showing a vehicle drive system to which an automatic transmission A4. As shown in the FIG. 11, a vehicle drive system includes an engine E, an automatic transmission A4, and a continuously variable transmission mechanism CVT.

The engine E is, similar to the first exemplary embodiment, an input shaft 2 of the automatic transmission A4 is coupled to an engine output shaft 1.

The belt continuously variable transmission mechanism CVT, similar to the first exemplary embodiment, acquires rotations of an output shaft 3 of an automatic transmission A4 as input rotations; outputs rotations by continuously changing transmission gear ratio depending on the contact diameter of a steel belt 6 which is put over a primary pulley 4 and a secondary pulley 5 outside the drawing; and outputs to the differential mechanism outside the drawing from an output shaft of a transmission casing 7.

The automatic transmission A4 includes a planetary gear unit (a double pinion planetary gear unit PG2); a plurality of frictional engagement elements to disconnect or fix the planetary gear elements s (a forward clutch Fwd/c, a higb/reverse clutch H&R/C, a low brake Low/B, a reverse brake REV/B). The variable speed control selects a low-speed forward gear as the vehicle first starts to move 1st, a high-speed forward gear when the vehicle is moving forward 2nd, and a reverse gear when the vehicle is moving reverse Rev. by disconnecting or fixing the plurality of frictional engagement elements.

A first damper Damp1 includes in a drive train pathway of all variable speed gears, and a second damper Damp2 includes in a drive train pathway of at least a low-speed forward gear among coupling members to couple the interspaces between a rotatory element of the planetary gear unit, input/output shafts 2 and 3, and a transmission casing TC. According to the fourth exemplary embodiment, a first damper Damp1 includes between an engine output shaft 11 and an input shaft 2; and a second damper Damp2 includes between a low brake Low/B and a transmission casing TC as shown in FIG. 1.

As shown in FIG. 11, the planetary gear unit is a double pinion planetary gear unit PG2 with a sun gear S, a pinion carrier C, and a ring gear R as rotatory elements, where the sun gear S is coupled to an input shaft 2. The pinion carrier C is coupled to a transmission casing TC by engaging a reverse brake REV/B, and at the same time, coupled to an output shaft 3 by engaging a forward clutch Fwd/C. The ring gear R is coupled to the transmission casing TC by engaging a low brake Low/B, and at the same time coupled to the output shaft 3 by engaging a hi/reverse clutch H&R/C.

The variable speed control comprises a low-speed forward gear 1st with the forward clutch Fwd/C and the low brake Low/B coupled, a high-speed forward gear 2nd with the forward clutch Fwd/C and the high/reverse clutch H&R/C coupled, and a reverse gear Rev. with the high/reverse clutch H&R/C and reverse brake REV/B coupled (refer to FIG. 13).

The double pinion planetary gear unit PG2 and the reverse brake REV/B are positioned on a first common axis D1 as shown in FIG. 11. The low brake Low/B, the high/reverse clutch H&R/C, and the forward clutch Fwd/C are positioned a second common axis D2 parallel to the first common axis D1. The reverse brake REV/B is a band-braking system where a brake drum provided on the outer circumference of a ring gear R is fixed on a transmission casing TC by tightening with a band.

FIG. 12 is a drawing showing the automatic transmission A4. A sun gear S of a double pinion planetary gear unit PG2 is coupled to an input shaft 2. A pinion carrier C of a double pinion planetary gear unit PG2 is coupled to a transmission casing TC by engaging a reverse brake REV/B, and at the same time, coupled to an output shaft 3 by engaging a forward clutch Fwd/C. A ring gear R of a double pinion planetary gear unit PG2 is coupled to a transmission casing TC by engaging a low brake Low/B, and at the same time, coupled to an output shaft 3 by engaging a high/reverse clutch H&R/C. In addition, a first damper Damp1 includes between the input shaft 2 and an engine output shaft 1; and a second damper Damp2 includes between the low brake Low/B and a transmission casing TC.

FIG. 13 is a table showing behaviors of connection and release of each variable speed gear of the automatic transmission A4. A low-speed forward gear 1st is obtained by coupling a forward clutch Fwd/C and a low brake Low/B, and releasing a high/reverse clutch H&R/C and a reverse brake REV/B. A high-speed forward gear 2nd is obtained by coupling a forward clutch Fwd/C and a high/reverse clutch H&R/C, and releasing a low brake Low/B and a reverse brake REV/B. A reverse gear Rev. is obtained by coupling a high/reverse clutch H&R/C and a reverse brake REV/B, releasing a forward clutch Fwd/C and a low brake Low/B.

FIG. 14 is a diagram of each variable speed gear of the automatic transmission A1 as described with respect to the fourth exemplary embodiment. As to a correlation of the number of rotations among a low-speed forward gear 1st, a high-speed forward gear 2nd, and a reverse gear Rev. As shown in the FIG. 14, a rigid lever model (the correlation of the number of rotations among the three is always connected by a straight line) can be introduced to exhibit dynamic movements of a double pinion planetary gear unit PG2 with a simple method.

At this point, each rotatory element of a double pinion planetary gear unit PG2 is positioned in the diagram in the order of a sun gear S, a ring gear R, and a pinion carrier C. The clearance between the pinion carrier C and ring gear R is the gear ratio λ given that the clearance between the sun gear S and pinion carrier C is 1. The gear ratio λ is usually 0.3-0.6, but given it is 0.5, for example, the transmission gear ratio of a reverse gear Rev. can be 1.

As shown in FIG. 16, the double pinion planetary gear unit PG2 fixes both ends of a pinion shafts PS1 and PS2 that rotatably supports a double pinion on a pair of pinion carriers C1 and C2, and it houses the pinion shafts PS1 and PS2 as a component of a carrier supporting structure. The pinion shafts PS1 and PS2 are fixed with both ends of the pinion shafts PS1 and PS2 by inserting the uneven end faces into holes opened in the pinion carrier C1 and C2, and, as shown in FIG. 16 (b), by welding one end with the other end fixed with bolts, or as shown in FIG. 16 (c), by welding one end with the other end crimped.

As shown in FIG. 15 (a), the conventional double pinion planetary gear unit PG2 has ensured a carrier supporting strength by arranging 3 sets of double pinion equally spaced at 120° between a sun gear and ring gear, and arranging a carrier supporting column (Section A) with a sufficient cross-sectional area between a double pinion which is adjacent in circumferential direction.

So as to enhance the gear strength to accept a high shift torque with this basic structure maintained, it is effective to increase the number of double pinion sets from 3 to 4. However, as shown in FIG. 15 (b), simply increasing the number of double pinion sets will not ensure sufficient carrier supporting strength because the cross-sectional area of the carrier supporting column (Section A) will be reduced.

Given this factor, when tightly connecting a pair of pinion carriers C1 and C2 with the bolt method+welding as shown in FIG. 16 (b) or with the crimp method+welding as shown in FIG. 16 (c), a relative displacement between the pinion shafts PS1 and PS2 and a pair of pinion carriers C1 and C2 can be prevented. The double pinion P1 and P2 can be prevented from becoming out of alignment against a pair of pinion carriers C1 and C2, which support opposite ends of the pinion shafts PS1 and PS2. The pinion shafts PS1 and PS2 can be prevented from leaning toward a pair of pinion carriers C1 and C2; therefore, a pair of pinion carriers C1 and C2 can be tightly connected with each other.

Thus, by tightly connecting a pair of pinion carriers C1 and C2 via the pinion shafts PS1 and PS2, the carrier supporting column (Section A) can be reduced or removed, and by maintaining the carrier supporting strength, the number of double pinion sets can be increased from 3 to 4.

As the vehicle first starts to move, input torque from an engine E will increase depending on a speed reduction ratio by selecting a low-speed forward gear 1st with a forward clutch Fwd/C and a low brake Low/B coupled because the engine will be reducing the speed with the number of output rotations into a sun gear S smaller than the number of input rotations into a pinion carrier C as shown by the 1st lever in FIG. 14.

After startup, for example, by selecting a high-speed forward gear 2nd when a speed of car reaches the predetermined speed, a forward clutch Fwd/C and a high/reverse clutch H&R/C are coupled as shown by the 2nd lever in FIG. 14. The transmission gear ratio is controlled at the side of a continuously variable transmission mechanism CVT because the number of input rotations from a sun gear R, and the number of output rotations from a pinion career C and a ring gear R becomes the same value (transmission gear ratio=1). The input torque from an engine E and the number of rotations are directly input into the belt continuously variable transmission mechanism CVT.

As shown by the Rev. lever in FIG. 14, selecting a reverse gear Rev. in a stopped state of the vehicle, the number of input rotations from a sun gear S and the number of output rotations from a ring gear R will create a rotational state in the reverse direction by coupling a hi/reverse clutch and a reverse brake REV/B. The vehicle will be put into reverse by inputting rotations, which the transmission gear ratio is almost 1, in the reverse direction into a continuously variable transmission mechanism CVT from an output shaft 3.

Thus, such is the case with an automatic transmission A4, it performs the function of a high-torque starting element by selecting a low-speed forward gear 1st as the vehicle first starts to move; and it performs the function of a forward/reverse shift mechanism by selecting a high-speed forward gear 2nd when the vehicle is moving forward, and a reverse gear Rev. when the vehicle is moving reverse. Size can be reduced in the axial direction by combining the high-torque starting element and the forward/reverse shift element in a double pinion planetary gear unit PG2 as compared to conventional technology that arranges the high-torque starting element and the forward/reverse shift element separately. Furthermore, the transmission gear ratio a the reverse gear Rev. can be 1 or close to 1, which it is virtually impractical for a single pinion planetary gear unit PG1 to achieve.

The fourth exemplary embodiment may provide one or more of the following advantages.

In the automatic transmission as described with respect to the fourth exemplary embodiment, the following listed effects, in addition to the first and second advantages of the first exemplary embodiment, can result.

Eighth, a planetary gear unit including a set of planetary gear elements is a double pinion planetary gear unit PG2 with a sun gear S, a pinion carrier C, and a ring gear R as rotatory elements. The sun gear S is coupled to an input shaft 2. The pinion carrier C is coupled to a transmission casing TC by engaging a reverse brake REV/B, and at the same time, coupled to an output shaft 3 by engaging a forward clutch Fwd/C. The ring gear R is coupled to the transmission casing TC by engaging a low brake Low/B, and at the same time coupled to the output shaft 3 by engaging a hi/reverse clutch H&R/C; and a high-torque starting element and a forward/reverse shift element can be reduced in a double pinion planetary gear unit PG2, two clutches Fwd/C and H&R/C, and two brakes Low/B and REV/B because the variable speed control consists of a low-speed forward gear 1st with the forward clutch Fwd/C and the low brake Low/B coupled, a high-speed forward gear 2nd with the forward clutch Fwd/C and the high/reverse clutch H&R/C coupled, and a reverse gear with the high/reverse clutch H&R/C and the reverse brake REV/B coupled.

Ninth, cost reduction can be achieved by standardizing and using common parts for rotatory members, and size can be reduced in the axial direction better than arranging frictional engagement elements at a distant position in the axial direction because a double pinion planetary gear unit PG2 and a reverse brake REV/B are positioned on a first common axis D1 as shown in FIG. 1. A low brake Low/B, a high/reverse clutch H&R/C, and a forward clutch Fwd/C are positioned on a second common axis D2 parallel to the first common axis D1.

In fact, common parts can be used as rotatory members adjacent to each frictional engagement element by making each frictional engagement element (a low brake Low/B, a high/reverse clutch H&R/C, a forward clutch Fwd/C) three-layer structure.

Tenth, in the reverse brake REV/B, dimensions can be reduced in the radial direction by adopting a band-braking system better than by adopting a multiplate brake system.

Eleventh, by removing the conventional carrier column and having pinion shafts PS1 and PS2 support the carrier, the number of pinion sets that provide high torque capacity can be increased because as shown in FIG. 16, the double pinion planetary gear unit PG2 fixes both ends of a pinion shafts PS1 and PS2 that rotatably supports a double pinion on a pair of pinion carriers C1 and C2 and it houses the pinion shafts PS1 and PS2 as a component of a carrier supporting structure.

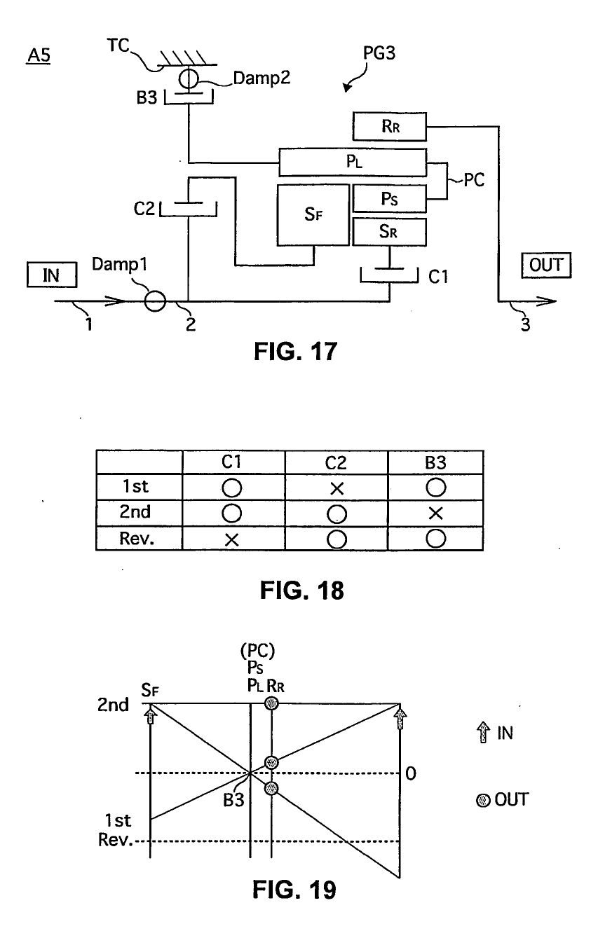

A fifth exemplary embodiment is described with reference to FIGS. 17-19. In particular, FIG. 17 is a drawing showing the automatic transmission A5. FIG. 18 is a table showing behaviors of clutches and brakes of each variable speed gear of the automatic transmission A5. FIG. 19 is a diagram showing a correlation of the number of rotations among each variable speed gear of the automatic transmission A5.

The fifth exemplary embodiment shows an example of a rear ring gear output using a Ravigneaux planetary gear unit with a front sun gear input or a rear sun gear input.

As shown in FIG. 17, a planetary gear unit including a set of planetary gear elements of the automatic transmission A6 as described with respect to the fifth exemplary embodiment is a front sun gear SF, a rear sun gear SR, a common pinion carrier PC which support a short pinion PS and a long pinion PL, and a Ravigneaux planetary gear unit PG3 with a rear ring gear RR as a rotatory element. The front sun gear SF is coupled to an input shaft 3 by engaging a first clutch C1, and at the same time, coupled to a transmission casing TC by engaging a first brake B1. The rear sun gear SR is coupled to an input shaft 2. The common pinion carrier PC is coupled to an output shaft 3. The rear ring gear RR is coupled to the transmission casing TC by engaging a second brake B2.

Then, as shown in FIG. 18, the variable speed control comprises a low-speed forward gear 1st with the first clutch C1 and the third brake B3 coupled, a high-speed forward gear 2nd with the first clutch C1 and the high and the second clutch C2 coupled, and a reverse gear Rev. with the second clutch C2 and the third brake B3 coupled. The first damper Damp1 includes between the input shaft 2 and the engine output shaft 1. The second damper Damp2 includes between the third brake B3 and a transmission casing TC

The transmission operates at variable speeds as follows. As the vehicle first starts to move, input torque from an engine E will increase depending on a speed reduction ratio by selecting a low-speed forward gear 1st with a first clutch C1 and a third brake B3 coupled because the engine will be reducing the speed with the number of output rotations from a rear sun gear SR smaller than the number of input rotations from a rear ring gear RR as shown by the 1st lever in FIG. 18.

After startup, for example, by selecting a high-speed forward gear 2nd as shown by the 2nd lever in FIG. 19 when a speed of car reaches the predetermined speed, the transmission gear ratio will be controlled at the side of a continuously variable transmission mechanism CVT because a first clutch C1 and a second clutch C2 are coupled. The number of input rotations from a rear ring gear RR, and the number of output rotations from a front sun gear SF and a rear sun gear SR become the same value (transmission gear ratio=1). The input torque from an engine E and the number of rotations are directly input into the belt continuously variable transmission mechanism CVT.

As shown by the Rev. lever in FIG. 18, by selecting a reverse gear Rev., the number of input rotations from a front sun gear SF and the number of output rotations from a rear ring gear RR will create a rotational state in the reverse direction by coupling a second clutch C2 and a third brake B3. The vehicle will be put into reverse by inputting rotations in the reverse direction into a continuously variable transmission mechanism CVT from an output shaft 3.

Thus, such is the case with the automatic transmission A5, it performs the function of a high-torque starting element by selecting a low-speed forward gear 1st as the vehicle first starts to move; and it performs the function of a forward/reverse shift mechanism by selecting a high-speed forward gear 2nd when the vehicle is moving forward, and a reverse gear Rev. when the vehicle is moving reverse. Size can be reduced in the axial direction by combining the high-torque starting element and forward/reverse shift element in a Ravigneaux planetary gear unit PG3 compared with a conventional technology to arrange a high-torque starting element and forward/reverse shift element separately.

The fifth exemplary embodiment may provide one or more of the following advantages. In the automatic transmission as described with respect to the fifth exemplary embodiment, the following listed effects, in addition to the first and second advantages of the first exemplary embodiment, can result.

Twelfth, the planetary gear unit is a front sun gear SF, a rear sun gear SR, a common pinion carrier PC which support a short pinion PS and a long pinion PL, and a Ravigneaux planetary gear unit PG3 with a rear ring gear RR as a rotatory element. The front sun gear SF is coupled to a input shaft 2 by engaging a first clutch C1, and at the same time, coupled to a transmission casing TC by engaging a first brake C1. The rear sun gear SR is coupled to an input shaft. The common pinion carrier PC is coupled to an output shaft 3. The rear ring gear RR is coupled to the transmission casing TC by engaging a second brake B2. A high-torque starting element and a forward/reverse shift element can be reduced in a Ravigneaux planetary gear unit PG3, a clutch C1, and two brakes C1,B2 because the variable speed control comprises a low-speed forward gear 1st with the first brake C1, a high-speed forward gear 2nd with the first clutch C1 coupled; and a reverse gear Rev. with the second brake B2 coupled. In fact, 3 frictional engagement elements, where the number of brakes is fewer than that of the first, second third and fourth exemplary embodiments, can ensure low-speed forward gear 1st, high-speed forward gear 2nd, and reverse gear Rev.

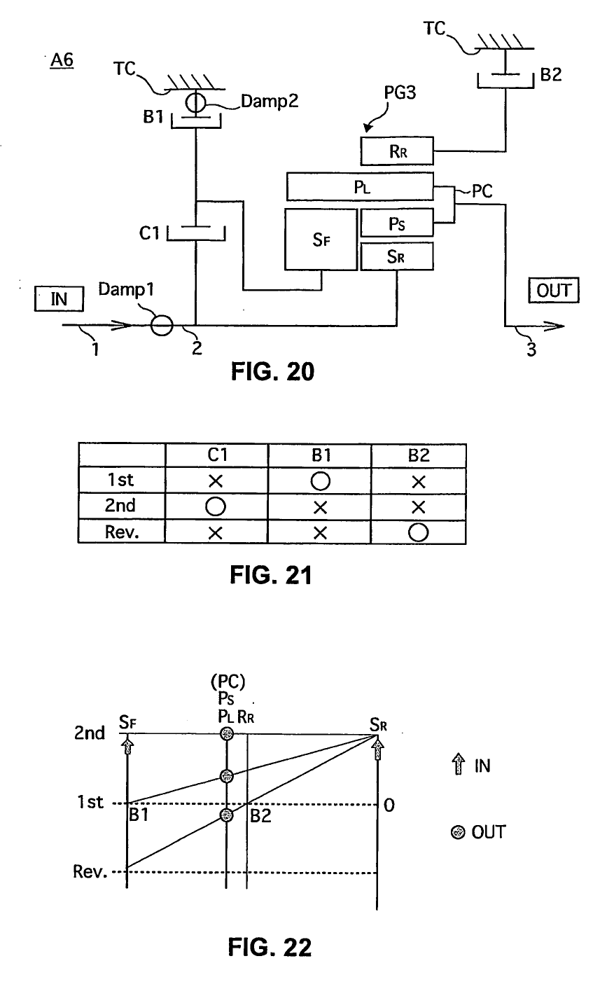

The sixth exemplary embodiment is described with reference to FIGS. 20-22. In particular, FIG. 20 is a drawing showing the automatic transmission A6. FIG. 21 is a table showing behaviors of clutches and brakes of each variable speed gear of the automatic transmission A6. FIG. 22 is a diagram showing a correlation of the number of rotations among each variable speed gear of the automatic transmission A6.

The sixth exemplary embodiment shows an example of a common pinion carrier output using a Ravigneaux planetary gear unit with a rear sun gear input, or a front and a rear sun gear input.

As shown in FIG. 20, a planetary gear unit including a set of planetary gear elements of the automatic transmission A6 include a front sun gear SF, a rear sun gear SR, a common pinion carrier PC which support a short pinion PS and a long pinion PL, and a Ravigneaux planetary gear unit PG3 with a rear ring gear RR as a rotatory element. The front sun gear SF is coupled to an input shaft 2 by engaging a first clutch C1, and at the same time, coupled to a transmission casing TC by engaging a first brake B1. The rear sun gear SR is coupled to an input shaft 2. The common pinion carrier PC is coupled to an output shaft 3. The rear ring gear RR is coupled to the transmission casing TC by engaging a second brake B2.

Then, as shown in FIG. 21, the variable speed control comprises a low-speed forward gear 1st with the first brake B1 coupled, a high-speed forward gear 2nd with the first clutch C1 coupled, and a reverse gear Rev. with the second B2 coupled. The first damper Damp1 includes between the input shaft 2 and an engine output shaft. The second damper Damp2 includes between the third brake B1 and transmission casing TC

The transmission operates at variable speeds as follows. As the vehicle first starts to move, input torque from an engine E will increase depending on a speed reduction ratio by selecting a low-speed forward gear 1st with a first brake B1 coupled because the engine will be reducing the speed with the number of output rotations from a rear sun gear SR smaller than the number of input rotations from a rear sun gear SR as shown by the 1st lever in FIG. 22.

After startup, for example, by selecting a high-speed forward gear 2nd as shown by the 2nd lever in FIG. 21 when a speed of car reaches the predetermined speed, the transmission gear ratio will be controlled at the side of a continuously variable transmission mechanism CVT because a first clutch C1 is coupled. The number of input rotations from a common pinion carrier PC, and the number of output rotations from a front sun gear SF and rear sun gear SR become the same value (transmission gear ratio=1). The input torque from an engine E and the number of rotations are directly input into the belt continuously variable transmission mechanism CVT.

As shown by the Rev. lever in FIG. 21, by selecting a reverse gear Rev., the number of input rotations from a rear sun gear SR and the number of output rotations from a common pinion carrier PC will create a rotational state in the reverse direction by coupling a second brake B2. The vehicle will be put into reverse by inputting rotations in the reverse direction into a continuously variable transmission mechanism CVT from an output shaft 3.

Thus, such is the case with the automatic transmission A6, it performs the function of a high-torque starting element by selecting a low-speed forward gear 1st as the vehicle first starts to move and performs the function of a forward/reverse shift mechanism by selecting a high-speed forward gear 2nd when the vehicle is moving forward, and a reverse gear Rev. when the vehicle is moving reverse. Size can be reduced in the axial direction by combining the high-torque starting element and forward/reverse shift element in a Ravigneaux planetary gear unit PG3 compared with a conventional technology to arrange a high-torque starting element and forward/reverse shift element separately.

The sixth exemplary embodiment may provide one or more of the following advantages. In the automatic transmission as described with respect to the sixth exemplary embodiment, the following listed effects, in addition to the first and second advantages of the first exemplary embodiment, can result.

Thirteenth, the planetary gear unit is a front sun gear SF, a rear sun gear SR, a common pinion carrier PC which support a short pinion PS and a long pinion PL, and a Ravigneaux planetary gear unit PG3 with a rear ring gear RR as a rotatory element. The front sun gear SF is coupled to a input shaft 2 by engaging a first clutch C1, and at the same time, coupled to a transmission casing TC by engaging a first brake B1. The rear sun gear SR is coupled to an input shaft. The common pinion carrier PC is coupled to an output shaft 3. The rear ring gear RR is coupled to the transmission casing TC by engaging a second brake B2. A high-torque starting element and a forward/reverse shift element can be reduced in a Ravigneaux planetary gear unit PG3, one clutch C1, and two brakes B1,B2 because the variable speed control comprises a low-speed forward gear 1st with the first brake B1, a high-speed forward gear 2nd coupled to the first clutch C1; and a reverse gear Rev. coupled to the second brake B2. In fact, 3 frictional engagement elements, where the number of clutches is fewer than that of embodiments 1-4 by one, can ensure a low-speed forward gear 1st, a high-speed forward gear 2nd, and a reverse gear Rev. Moreover, each variable speed gear can be ensured by coupling each frictional engagement elements.

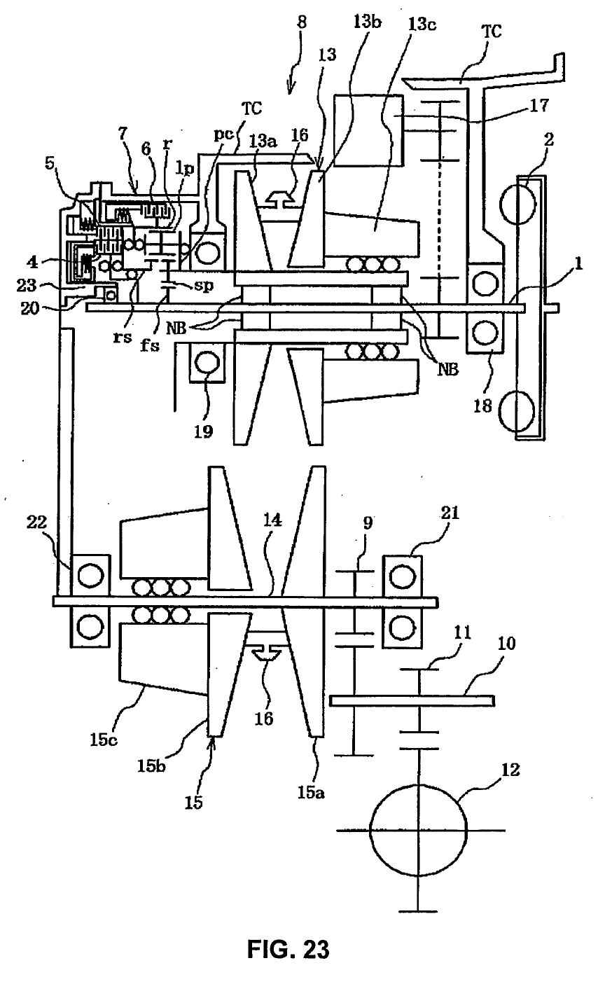

FIG. 23 is a drawing showing a mode for carrying out a belt type continuously variable transmission. The embodiment shown in FIG. 23 differs from the first through sixth exemplary embodiments in that in FIG. 23 input shaft 1 passes through a continuously variable transmission mechanism 8. While the embodiment shown in FIG. 23 is described in specific detail, each of the first through sixth exemplary embodiments can be adapted to a similar configuration.

An engine output shaft, not shown in FIG. 23, is coupled to an input shaft of the transmission 1 via a torsional damper 2. The belt type continuously variable transmission includes a starting friction element 7, a belt type continuously variable transmission mechanism 8 that continuously transmits between the input and output gears, an output gear 9, an idler shaft 10, a reduction gear 11 and a differential gear 12. Starting friction element 7 is equipped with a forward clutch 4, a forward brake 5, and a reverse brake 6. The idler shaft 10, the reduction gear 11 and the differential gear 12 reduce the output speed.

The torsional damper 2, where its input shaft is coupled to an engine output shaft, and its output shaft is coupled to an input shaft of the transmission 1, is comprised so that the input shaft and output shaft of torsional damper 2 are coupled via a torsional spring to enable relative rotation.

The starting friction element 7 includes a Ravigneaux type planetary gear which is able to change the rotational direction and gear ratio as follows. The forward clutch 4 coupled when the vehicle is moving forward at high speed. The forward brake 5 coupled when the vehicle is moving forward at low speed, and the reverse brake 6 coupled when the vehicle is moving backward.

The Ravigneaux type planetary gear includes a front sun gear fs that rotates in the same concentric pattern as the input shaft of the transmission 1, a rear sun gear rs, a plurality of long pinions lp that engage with the rear sun gear rs on its outer circumference, a short pinion sp that engages with the front sun gear fs and long pinions lp on the outer circumference of the front sun gear fs, a ring gear r which engages with the long pinions lp on its outer circumference and a common carrier pc that rotatably supports both the long pinion and the short pinion sp. The sun gear fs is coupled to the input shaft of the transmission 1 which runs through the inner periphery of the primary pulley 4 that composed of the belt type continuously variable transmission mechanism 8 by being rotatably supported by a needle bearing NB; and the carrier pc is coupled to a fixing sieve 13a of a sieve primary pulley 13 with its inner periphery side cylindrical.

The forward clutch 4 includes a plurality of plates coupled to the input shaft of the transmission 1 and a plurality of plates coupled to the rear sun gear rs. The forward clutch 4 can selectively engage by generating hydraulic pressure for clutch driving to a piston, not shown in FIG. 23, to push the plurality of plates coupled to the input portion and the plurality of plates coupled to the rear sun gear rs together. The forward clutch 4 can selectively disengage by reducing or reversing the hydraulic pressure.

The forward brake 5 includes a plurality of plates coupled to the transmission casing TC and a plurality of plates coupled to the rear sun gear rs. The forward brake 5 can selectively engage by generating hydraulic pressure for clutch driving to a piston, not shown in FIG. 23, to push the plurality of plates coupled to the transmission casing TC and the plurality of plates coupled to the rear sun gear rs together. This causes the rear sun gear rs to be fixed to the transmission casing TC. The forward brake 5 can selectively disengage by reducing or reversing the hydraulic pressure.

The reverse brake 6 includes a plurality of plates coupled to the transmission casing TC and a plurality of plates coupled to the rear ring gear r. The reverse brake 6 can selectively engage by generating hydraulic pressure for clutch driving to a piston, not shown in FIG. 23, to push the plurality of plates coupled to the transmission casing TC and the plurality of plates coupled to the rear ring gear r together. The causes the ring gear r to be fixed to the transmission casing TC. The reverse brake 6 can selectively disengage by reducing or reversing the hydraulic pressure to free the rear ring gear r from the transmission casing.

In the starting friction element 7, if the low-speed forward gear is selected by only coupling the forward brake 5, input torque from an engine will increase depending on the speed reduction ratio because the speed reduction state will be selected where the number of rotations of the common carrier pc is smaller than that of the rear sun gear rs. If the high-speed forward gear is selected by only coupling the forward clutch 4, the transmission gear ratio will be controlled only at the side of the belt type continuously variable transmission mechanism 8 because the number of rotations from the front sun gear fs and the rear sun gear rs, and the number of rotations of the common carrier pc will be the same; and the input torque from the engine and the number of rotations are directly input into the fixing sieve 13a of a sieve primary pulley 13 of the belt type continuously variable transmission mechanism 8. If a reverse gear is selected by only coupling the reverse brake 6, the same rotational direction of the common carrier pc can be opposite to that of the rear sun gear rs.

The belt type continuously variable transmission mechanism 8 may continuously change the transmission gear ratio between the input/output shafts. The belt type continuously variable transmission mechanism 8 includes the primary pulley 13 coupled to the common carrier pc, a secondary pulley 15 coupled to a secondary pulley axis 14, and a CVT belt 16 which is put over the primary pulley 13 and the secondary pulley 15. The primary pulley 13 and the secondary pulley 15 include the fixing sieve 13a,15a and a mobile sieve 13b,15b which approaches to, become separated from, and become displaced toward the fixing sieve 13a,15a Pistons 13c,15c may continuously change transmission gear ratio according to the hydraulic pressure applied with a hydraulic pressure control unit (not shown in FIG. 23). In the hydraulic pressure control unit, pressure oil is absorbed from an oil tank, not shown in the figure, and supplied with an oil pump 17.

The input shaft of the transmission 1 is rotatably supported at its front side in the transmission casing TC via an axle bearing 18. The input shaft of the transmission 1 is rotatably supported in an intermediate position in the axial direction via an axle bearing 19, the common carrier pc, the fixing sieve 13a, and the needle bearing NB. The input shaft of the transmission 1 is rotatably supported at its rear side in the transmission casing TC via an axle bearing 20.

In the belt type continuously variable transmission 8, the torsional damper 2, oil pump 17, primary pulley 13, and starting friction element 7 are placed in the input shaft of the transmission 1 as a primary shaft starting from the engine side. The fixing sieve 13a of the sieve primary pulley 13, and its piston for driving 13c are placed in the engine side. The output gear 9 and secondary pulley 15 are placed in the secondary pulley axis 14 as a secondary axis starting from the engine side. The mobile sieve 15b of the secondary pulley 15 and its piston for driving 15c are placed in the opposite side to the engine. The secondary pulley 15 and output gear 9 are placed adjacent to each other in the axial direction.

The total length in the axial direction of the transmission can be shortened adjusting the position of the opposite end of the first axis and second axis to the engine in the axial direction by placing the fixing sieve 13a of the sieve primary pulley 13 at the engine side; by placing the mobile sieve 15b of the secondary pulley 15 in the opposite side to the engine, and by having the opposite side to the engine of the secondary pulley 15 projecting against the opposite side to the engine so that the starting element can be arranged in the expansion gap created in opposite side to the engine of the primary axis side by the projection.

Furthermore, so as to conform the position in the axial direction of the axis bearing 20 placed at the farthest opposite side to the engine of the input shaft of the transmission 1 as the primary axis, and the position in the axial direction of the starting friction element 7, the forward clutch 5 is made to be cylindrical externally wrapping the relevant axis bearing 20 by supporting the axis bearing 20 on the outer circumference by a cylindrical support hole 23 having the axis bearing 20 projecting from the transmission casing TC from the engine side.

According to this, the length in the axial direction of the input shaft of the transmission 1 can be shortened because the axis bearing 20 is placed by having the position in the axial direction of the axis bearing 20 wrapped against the forward clutch 5.

Descriptions of the automatic transmission of the invention are given based on exemplary embodiments. Consistent with principles of the invention, specific structures are not limited to these embodiments. For example, the single or double type planetary gear mechanism can be used instead of the Ravigneaux type planetary gear mechanism.

A planetary gear unit including a set of planetary gear elements is explained with a single pinion planetary gear unit PG1, a double pinion planetary gear unit PG2, and a Ravigneaux planetary gear unit PG3 in the exemplary embodiments; however, a planetary gear unit is not limited to the one as described with respect to the described exemplary embodiments as long as it constitutes a planetary gear unit including a set of planetary gear elements.

Descriptions of a second clutch and a second brake (the first through fourth exemplary embodiments), a second clutch and a first brake (the fifth exemplary embodiment), and a first clutch and a second brake (the fifth exemplary embodiment) are given as a plurality of frictional engagement elements to disconnect or fix the pair of planetary gear unit, but not limited to these. In short, at least a low-speed forward gear selected as the vehicle first starts to move, a high-speed forward gear selected when the vehicle is moving forward, and a reverse gear when the vehicle is moving reverse should be ensured by disconnecting or fixing the plurality of frictional engagement elements.

Examples where a transmission unit comprises an automatic transmission in the described exemplary embodiments as a sub-transmission, and a continuously variable transmission mechanism CVT as a main transmission are given. However, the main transmission is not limited to the belt continuously variable transmission mechanism CVT, but it can be replaced with a hydraulic automatic transmission which is not provided with reverse functions.

The automatic transmission described herein can be applied to, for example, an electric automobile with an electrically-driven motor as a source of power, or a hybrid vehicle with an engine and an electrically-driven motor as a source of power. Concerning an electric automobile and hybrid vehicle, for example, an automatic transmission provided with both a high-torque starting element and forward/reverse shift element is desired. As for an electric automobile and hybrid vehicle, if the maximum motor output can be reduced against a driving torque required by the high-torque starting element, the electrically-driven motor can be downsized. Furthermore, if the forward/reverse shift element can change between a forward rotation and reverse rotation by simply turning over the motor in one direction, efficiency of the electrically-driven motor can be improved.

Various embodiments of the invention have been described.

These and other embodiments are within the scope of the following claims.

1. An automatic transmission comprising:
a planetary gear unit coupled a transmission mechanism, wherein a drive train pathway of the automatic transmission includes the transmission mechanism and the planetary gear unit; and
a plurality of engagement elements that engage to couple planetary gear elements of the planetary gear unit, wherein the plurality of engagement elements are selectively engaged to provide each of a set of selectable gears, wherein the set of selectable gears includes:
a low-speed forward gear,
a high-speed forward gear, and
a reverse gear.

2. The automatic transmission of claim 1, wherein the transmission mechanism is a continuously variable transmission mechanism.

3. The automatic transmission of claim 1, further comprising:
a transmission casing;
a first damper in the drive train pathway; and
a second damper coupled to an engagement element of the set of engagement elements that couples interspaces between rotatory elements of the planetary gear elements and the transmission casing.

4. The automatic transmission of claim 1, further comprising an input shaft,
wherein the planetary gear unit is a single pinion planetary gear unit including a sun gear, a pinion carrier, and a ring gear as rotatory elements,
wherein the sun gear is coupled to the input shaft.

5. The automatic transmission of claim 4, further comprising:
a transmission casing; and
an output shaft,
wherein the plurality of engagement elements includes a reverse brake, a forward clutch, a low brake and a high/forward clutch,
wherein the pinion carrier may be selectively coupled to the transmission casing by engaging the reverse brake, and may be selectively coupled to the output shaft by engaging the forward clutch,
wherein the ring gear may be selectively coupled to the transmission casing by engaging the low brake, and may be selectively coupled to the output shaft by engaging the high/reverse clutch.

6. The automatic transmission of claim 5,
wherein the low-speed forward gear is selected by engaging both the low brake and the forward clutch,
wherein the high-speed forward gear is selected by engaging both the high/reverse clutch and the forward clutch, and
wherein the reverse gear is selected by engaging both the high/reverse clutch and the reverse brake.

7. The automatic transmission of claim 5,
wherein the single pinion planetary gear unit and the reverse brake are positioned on a first common axis,
wherein the low brake, the high/reverse clutch, and the forward clutch are positioned on a second common axis adjacent to the first common axis.

8. The automatic transmission of claim 7, wherein the second common axis is parallel to the first common axis.

9. The automatic transmission of claim 5, wherein the reverse brake includes a band-braking system.

10. The automatic transmission of claim 1, further comprising an output shaft,
wherein the planetary gear unit is a single pinion planetary gear unit including a sun gear, a pinion carrier, and a ring gear as rotatory elements,
wherein the ring gear is coupled to the output shaft.

11. The automatic transmission of claim 10, further comprising a transmission casing,
wherein the plurality of engagement elements includes a reverse brake, a high/reverse clutch, a low brake and a forward clutch,
wherein the sun gear may be selectively coupled to the transmission casing by engaging the low brake, and may be selectively coupled to the output shaft by engaging the high/reverse clutch,
wherein the pinion carrier may be selectively coupled the transmission casing by engaging the reverse brake, and at may be selectively coupled to the output shaft by engaging the forward clutch.

12. The automatic transmission of claim 11,
wherein the low-speed forward gear is selected by engaging both the low brake and the forward clutch,
wherein the high-speed forward gear is selected by engaging both the high/reverse clutch and the forward clutch, and
wherein the reverse gear is selected by engaging both the high/reverse clutch and the reverse brake.

13. The automatic transmission of claim 10, further comprising:
a transmission casing; and
an input shaft,
wherein the plurality of engagement elements includes a high brake, a low/reverse clutch, a reverse brake and a forward clutch,
wherein the sun gear may be selectively coupled to the transmission casing by engaging the high brake, and may be selectively coupled to the input shaft by engaging the low/reverse clutch,
wherein the pinion carrier may be selectively coupled to the transmission casing by engaging the reverse brake, and may be selectively coupled to the input shaft by engaging the forward clutch.

14. The automatic transmission of claim 13,
wherein the low-speed forward gear is selected by engaging both the low/reverse clutch and the forward clutch,
wherein the high-speed forward gear is selected by engaging both the high brake and the forward clutch, and
wherein the reverse gear is selected by engaging both the low/reverse clutch and the reverse brake.

15. The automatic transmission of claim 1, further comprising:
a transmission casing;
an input shaft; and
an output shaft,
wherein the planetary gear unit is a double pinion planetary gear unit including a sun gear, a pinion carrier, and a ring gear as rotatory elements,
wherein the sun gear is coupled to the input shaft,
wherein the plurality of engagement elements includes a low brake, a high/reverse clutch, a reverse brake and a forward clutch,
wherein the pinion carrier may be selectively coupled to the transmission casing by engaging the reverse brake, and may be selectively coupled to the output shaft by engaging the forward clutch,
wherein the ring gear may be selectively coupled to the transmission casing by engaging the low brake, and may be selectively coupled to the output shaft by engaging the high/reverse clutch,
wherein the low-speed forward gear is selected by engaging both the low brake and the forward clutch,
wherein the high-speed forward gear is selected by engaging both the high/reverse clutch and the forward clutch, and
wherein the reverse gear is selected by engaging both the high/reverse clutch and the reverse brake.

16. The automatic transmission of claim 15,
wherein the double pinion planetary gear unit and the reverse brake are positioned on a first common axis,
wherein the low brake, the high/reverse clutch, and the forward clutch are positioned on a second common axis adjacent to the first common axis.

17. The automatic transmission of claim 16, wherein the reverse brake includes a band-braking system.

18. The automatic transmission of claim 15, further comprising a set of pinion shafts to axially support a corresponding set of pinion gears
wherein the pinion carrier is a first pinion carrier, further comprising a second pinion carrier,
wherein the first pinion carrier and the second pinion carrier support support opposite ends of the set of pinion shafts.

19. The automatic transmission of claim 1, further comprising:
a transmission casing;
an input shaft; and
an output shaft,
wherein the planetary gear unit includes:
a front sun gear,
a rear sun gear,
a common pinion carrier which supports a short pinion and a long pinion, and
a Ravigneaux planetary gear unit with a rear ring gear as a rotatory element,
wherein the rear ring gear is coupled to the output shaft,
wherein the plurality of frictional engagement elements includes a first clutch, a second clutch, and a third brake,
wherein the front sun gear may be selectively coupled to the input shaft by engaging the second clutch,
wherein the rear sun gear may be selectively coupled to the input shaft by engaging the first clutch,
wherein the common pinion carrier may be selectively coupled to the transmission casing by engaging the third brake,
wherein the low-speed forward gear is selected by engaging both the first clutch and the third brake,
wherein the high-speed forward gear is selected by engaging both the first clutch and the second clutch, and
wherein the reverse gear is selected by engaging both the second clutch and the third brake.

20. The automatic transmission of claim 1, further comprising:
a transmission casing;
an input shaft; and
an output shaft,
wherein the planetary gear unit includes:
a front sun gear,
a rear sun gear,
a common pinion carrier which supports a short pinion and a long pinion,
a Ravigneaux planetary gear unit with a rear ring gear as a rotatory element,
wherein the rear sun gear is coupled to the input shaft,
wherein the common pinion carrier is coupled to output shaft,
wherein the plurality of frictional engagement elements includes a first brake, a second brake, and a first clutch,
wherein the front sun gear may be selectively coupled to the input shaft by engaging the first clutch, and may be selectively coupled to the transmission casing by engaging the first brake,
wherein the rear ring gear may be selectively coupled to the transmission casing by engaging the second brake;
wherein the low-speed forward gear is selected by engaging the first brake,
wherein the high-speed forward gear is selected by engaging the first clutch, and
wherein the reverse gear is selected by engaging the second brake.
